(19) United States
(12) Patent Application Publication
(10) Pub. No.: US 2024/0084705 A1
(43) Pub. Date: Mar. 14, 2024

(54) Airfoil Superstructure

(71) Applicant: Galen Suppes, Columbia, MO (US)

(72) Inventor: Galen Suppes, Columbia, MO (US)

(73) Assignee: The Suppes Family Trust, Columbia, MO (US)

(21) Appl. No.: 17/971,107

(22) Filed: Oct. 21, 2022

Related U.S. Application Data
(60) Provisional application No. 63/406,272, filed on Sep. 14, 2022.

(51) Int. Cl. F01D 5/14; B64C 3/14; B64C 11/18; B64C 27/467

(52) U.S. Cl. CPC F01D 5/141; B64C 3/14; B64C 11/18; B64C 27/467; F05D 2220/323; F05D 2240/30

(57) ABSTRACT

An airfoil is configured to reduce lift pressures in relaxing spans adjacent to the airfoil's tip to avoid vortex formation. The relaxing span is configured to enable negative air angles of attack on thin airfoils to reduce pressure differences. The configuration enables more-efficient long-chord blunt edges/tips on low aspect ratio airfoils having utility in a plurality of applications including aircraft wings, turbine blades, and ductless fans.

### CROSS REFERENCE TO RELATED APPLICATIONS

This application is a continuation-in-part of Provisional Appl. Ser. No. 63/406,272 filed on 14 Sep. 2022 entitled “Plate Airfoil with Blunt Span Ends”. The above-listed applications are incorporated by reference in their entirety herein.

### FIELD

The present invention relates to airfoil designs to reduce side end effects related to undesirable vortex formations that reduce performance. Applications include wings of fixed wing aircraft, rotary wings, turbines, compressors, ductless fans, and ductless turbojets.

### BACKGROUND

The science of lift identifies that airfoil performance can be far greater than contemporary achievements. In terms of aerodynamic lift, that science is:
For any point on the surface, the lift is cos(θ) ΔP dS, the form drag is sin(θ) ΔP dS, and the lift-to-drag ratio (“L/D”) is tan⁻¹(θ), where: θ° is air's angle of attack in degrees, P is pressure, S is a surface's area, and form drag is the total drag when neglecting shear drag. For a flat plate, 0° is constant, and the limit for a large thin flat plate (negligible edge surface area) is: L/D=57/θ° (at low θ°).
   Even when taking into account shear drag and the form drag of a leading edge, that science identifies attainable L/D more than three times the best contemporary airliners. The key to attaining these high efficiencies is a predominance of surfaces with 0° between −1 and 1.

Suppes (PCT/US22/14884) disclosed a towed platform approach to provide passive pitch stability and longitudinal robustness (through flexibility) for thin airfoils of aspect ratios typically less than 0.5. The flexibility may be imparted through flexible connections such as: a) hinge joint, b) flexible polymer strips, and c) a pair of laterally-narrow connections such as ball joints or ropes. The instant application provides a solution to side-edge vortex-related losses that can occur on towed platform structures.

Contemporary solutions to mitigate tip vortex losses include: a) winglets, b) sword-type tips that remove the parts of the airfoil most adversely impacted, and c) ducts. The impact of these solutions include turbofans, turbojets, and wind turbines; all of which would benefit from the improved methods of the embodiments of current innovations to mitigate vortex-related losses.

### SUMMARY OF THE INVENTION

The airfoil embodiments of this invention are on cruising configurations of aircraft and preferred high-efficiency modes of operation of rotating blades. The airfoils are engineered structures where lift pressures are generated through aerodynamic interaction with surfaces at airfoil spans removed from the tip (also referred to as a side edge); those lift pressures spread laterally (or radially) outward as a result of air flowing from higher to lower pressures. Over outboard spans, aerodynamic interaction a negative air angles of attack create pressures opposite the lift pressures; and in span progression to the tip cumulative (sum of upper and lower surface) lift pressures decrease, approaching zero lift pressure with elimination of the driving force which causes tip vortices. Over the outboard span, lift continues to be generated, but at lower magnitudes; this enables use of thin light-weight outboard span sections that generate induced thrust. The predominance of cumulative lift pressures over the outboard avoids upwash, which is undesirable when cruising.

For rotating blades the lateral and span dimensions are radial dimensions of the blade. For rotating blades, desired lift pressures are pressure and suction pressures and upwash is backwash. The separate evolution of these technologies has led to different terms, but the basic fluid dynamics when coupling generating spans with relaxing spans (i.e. airfoil superstructures) is the same.

The airfoil superstructure is an airfoil span that generates lift pressure (or flow pressure of a blade) at an inboard span and a midboard span; the generated lift pressure spreads to an outboard span where aerodynamic forces reduce the lift pressure to a very low value at a semispan tip. In subsequent specifications, terminology associated with aircraft wings is used; however, instant invention has applications in a variety of devices using airfoils, including but not limited to: wings, fans, turbines, blades, propellers, aircraft, flattop aircraft, towed [aerial] platforms, electric motor, kites, solar kites, wind turbines, wind turbines attached to a kite (“kite turbine”), pinwheel fans, a kite turbine attached to a telescopic post, a ductless turbofan, a ductless turbojet, and a hybrid electric-fuel jet engine.

### FIGURES

FIG. 1 is an example airfoil superstructure connected to a payload bulge having thickness of 0.02 MAC: a) illustrating fifteen airfoil elements with symmetry about longitudinal-vertical center plane, b) longitudinal inboard, midboard, and outboard cross sections, and c) lateral cross sections at 0.1, 0.4, and 0.9 chord. Rounded edges and overlap of elements exemplify changes in pitches of the elements.

FIG. 2 is a top and bottom perspectives of FIG. 1 airfoils superstructure with modifications of swept leading edge and hinge joint between lead platform and towed platform.

FIG. 3 is an illustration of lift pressure profiles at 0.8 chord showing some interference of fuselage with lift. Reduced lift pressure is the lower surface pressure minus the upper surface pressure divided by the maximum of this quantity at that chord. The reduced half span is the lateral distance from the center divided by the semispan distance.

FIG. 4 is an illustrates S-shaped camber of midboard spans with flat surface form 0.01 to 0.15 chord: a) a very thin span, b) a span with structural bulge at 0.35 chord, and c) a span with flat narrow leading airfoil element and structural bulge at 0.5 chord.

FIG. 5 is an illustration of an aircraft with airfoil super structure wing, solar panels, elevons, and hybrid electric-fuel jet engine.

FIG. 7 is an illustration of a wind turbine blade with superstructure airfoil span at r>0.8 R.

FIG. 8 is an expanded view of airfoil superstructure span on wind turbine of FIG. 7.

FIG. 9 is an illustration of fan blade showing suction side of airfoil superstructure end.

FIG. 10 is an illustration of fan blade showing change in pitches from inboard to outboard portions of superstructure end.

FIG. 11 is a perspective of an airfoil superstructure similar to FIG. 1, but with sheets as the outboard span.

FIG. 12 is a bottom view perspective of airfoil superstructure with increased use of pressure-adaptive sheets at aft. Structural vanes with wheels and air-throttling gaps shown.

FIG. 13 is a perspective of a flattop aircraft with lead propulsor and hinge joint on airfoil superstructure.

FIG. 14 is an algorithm to optimize airfoil superstructures.

FIG. 15 is a cutaway view of a hybrid electric-fuel engine with open-burner engine.

FIG. 16 is a cross section of a hybrid electric-fuel engine.

FIG. 17 are cross section view of various blade configurations for open-burner engine.

FIG. 18 is a front view of a hybrid electric fuel ramjet engine.

FIG. 19 illustrates views of rotating combustor nozzle in compressor blade assembly.

FIG. 20 illustrates alternative views of FIG. 15 hybrid electric-fuel engine, including: a) an exploded view, b) a trailing end perspective, and c) a leading end perspective.

FIG. 21 provides a perspective on induction motor devices for use with hybrid jet engine.

FIG. 22 illustrates a coupling of an excitation means with an induction circuit system.

FIG. 23 illustrates a towed aircraft pulled by a linear motor.

FIG. 24 is a graphical comparisons of the lift-to-drag ratios of an ideal flat plate airfoil compared to a contemporary airfoil having a maximum thickness of about 6% MAC.

### DEFINITIONS

Definitions of the following terms are incorporated by reference from Halsey (U.S. Pat. No. 3,576,086 A): Angle of Attack, Angle of Incidence, Aspect Ration (A/R), Camber, Chord, Dihedral Angle, Leading Edge Radius, Lift Drag Ration (L/D), Mean Aerodynamic Chord (MAC), Semispan, Span, Vortex, Washout, Wing Root, Zero Lift Chord. Those and the following additional reference are part of the specification of instant invention embodiments.

0.8 R—Where R is a blades radius of rotation, 0.8 R is the radius eight tenths the distance from the axis of rotation to the radius of the blade. Different fractions may be used. R is the maximum radius; r is radius as varying from 0 R to 1.0 R.

Airfoil Superstructure—An airfoil span that includes a relaxing span coupled with (and laterally or radially outward from) a generating span to which the relaxing span is attached.

Baseline Wing and Baseline Wingspan—is that portion of the wing considered the aerodynamic lifting surface of the wing; it does not include winglets having substantial (>45°) vertical orientations. Halsey's definition of “span” is further defined as the span of the baseline wing. The embodiments of this invention have lifting surfaces continue above and/or below any fuselage embodiments, and so, the semispan goes from a centerline to the tip. For rotating blades/wings; herein, the baseline wing is the out most 40% to 20% of the blades radial span.

Control Surfaces—are surfaces control devices like elevons, ailerons, and flaps. For instant document the control surface is consider part of the baseline wing if it generates lift; the position of the control surface is indirectly specified per the definition of the Cruising Configuration.

Cruising Configuration—Is a steady-state flight condition, further specified as a condition where altitude, speed, and control surface positions are constant. In a case of incomplete specification of this document, the cruising condition is where the airfoil is 1° nose up from the condition of zero lift.

Generating Section (or Generating Span)—Is an inboard and/or midboard span of an airfoil that generates desired lift, pressure, and/or suction through fluid dynamic forces.

Camber (negative)—A negative camber is convex downward.

Open-Burner Jet Engine—Substantially the same as a ductless jet engine.

Outboard, Inboard, Midboard—The baseline wing is further divided into spans, from root to tip, of inboard, midboard, and outboard. The outboard is the outer 10% span of the baseline wing. The inboard may have a fuselage attached to it. The absolute transition span from inboard to midboard may be embodiment-specific. All are substantially laterally horizontal (i.e., the outboard does not include a winglet attached to the airfoil side edge).

Pitch (Platform or Airfoil versus Surface)—Pitch in a cruising configuration in degrees is the dihedral angle between the chord and a horizontal plane; positive is leading edge up. For a surface, it is the dihedral angle of the surface's cross-section's (in longitudinal-vertical plane) tangent line and a horizontal plane.

Planform—the shape or outline of an aircraft wing as projected upon a horizontal plane.

Relaxing Section (or Relaxing Span)—Is an outboard span of an airfoil over which air/fluid flows in/out from/to an adjacent midboard span; negative air/fluid angles of attack on the relaxing span cause a pressure contribution opposite the in/out flow which lowers absolute values of the pressure over the relaxing span

Steady-State—Operating without change in condition with time. Examples are an aircraft cruising without change in altitude or speed and a rotating blade operating at a constant speed. Herein, a steady-state condition is with control surfaces at a fixed position. Herein, it includes pseudo-steady-state conditions which allows for slight changes in weight due to chemical reactions (e.g., fuel consumption).

Structural Vane—A vane is a thin vertical surface parallel to the air/fluid flow. A structural vane imparts the strength of its vertical dimension to provide longitudinal strength and robustness to a thin airfoil. The connection of a structural vane may impart lateral strength.

Thickness Ratio—Unless otherwise stated, thickness in an average thickness typically expressed as a fraction of MAC. An example average thickness specification is “a thickness of 0.01 MAC”. An example specification of a maximum thickness in a span is “a thickness <0.05 MAC”.

Tip (e.g., airfoil tip)—Herein, refers to the end or side edge where the term does not imply a pointed tip and does include blunt ends with long chords.

Upwash—The trivial wash (not presently considered upwash or downwash) of all aircraft is the flow of higher pressure air to lower pressure air at the leading edge or trailing edge of an airfoil. For the present document, downwash is a trailing-edge phenomena when the lower surface vectors higher-pressure air downward and away from lower pressure air above the vectored flow. Upwash is a trailing-edge phenomena when the upper surface vectors higher-pressure air upward and away from lower pressure air below the vectored flow. Downwash is not necessary for cruising flight of a fixed-wing aircraft. Downwash becomes increasingly necessary when the mass of an aircraft is gaining altitude; it is a manifestation of the need to conserve momentum.

### DETAILED EMBODIMENT

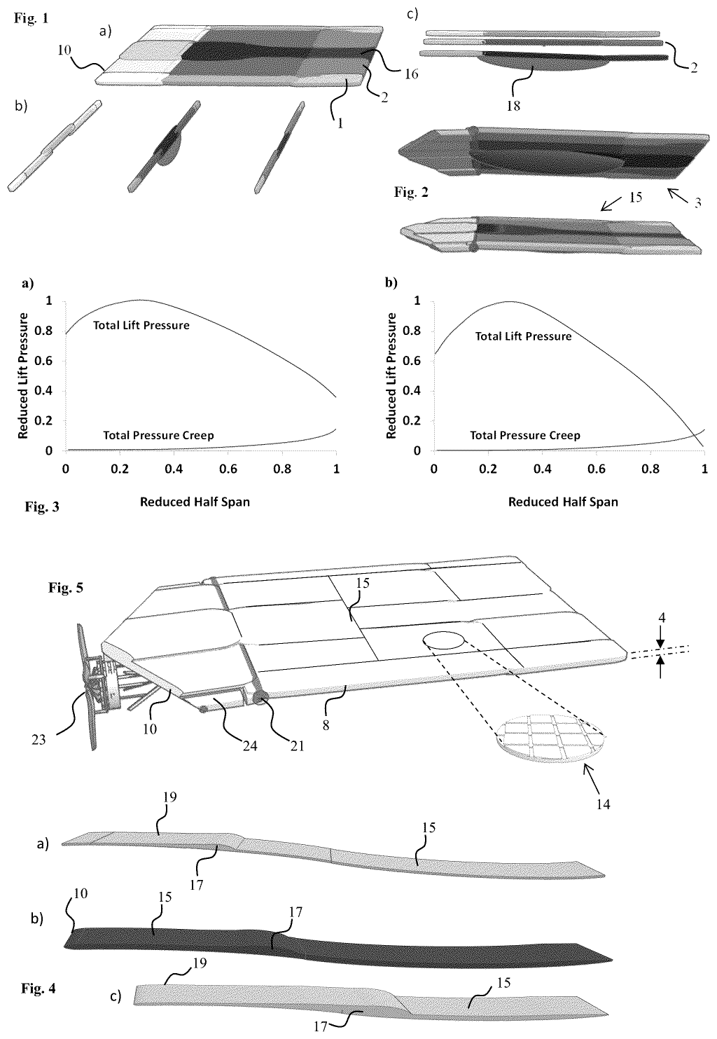

Outboard Span—The airfoil span comprises an outboard span 1 adjacent to a midboard span 2 (see FIGS. 1 and 2); the midboard span s is configured to generate pressure on a midboard 2 lower surface 3; and the outboard span comprises an average thickness 4 between 0.0001 and 0.015 MAC 5 and is configured to: a) reduce pressure differences between upper and lower surfaces (see FIG. 3), b) reduce vortex magnitudes without upwash and c) operate at median fluid angles of attack between −2° and 0°. The term “reduce vortex magnitude” means reduce relative to a baseline outboard span configured to cruise with positive air angles of attack.

For a more-preferred airfoil span, the outboard span 1: a) comprises an average thickness less than 0.01 MAC and a median pitch between −1.5° and −0.1°, b) comprises a sheet 6 configured to passively decrease pitch in response to higher lift pressures, c) is part of a baseboard wing 7, the baseboard wing comprising an aspect ratio between 0.1 and 3 and wherein >95% of the baseboard 7 extends laterally at least 95% of the baseboard's wingspan, d) is part of a wing comprising edges 8 9 10 wherein the wing is configured to operate at cumulative lift pressures between 0 and 0.25 kPa at the edges, e) is connected to a structural vane 11 wherein the vane is configured to increase the longitudinal rigidity of the outboard span and f) is the outer one tenth of the baseboard wing's semispan. An inboard “generating” span section is typically about four tenths of the baseboard wing's semispan.

The preferred and more preferred embodiments are summarized by Table 1 infra.

TABLE 1
Parametric specification of key design features of airfoil superstructures.

| Specification | Preferred (More Preferred, Most Preferred) |
|---|---|
| Thickness at 0-0.15 Chord | 0.01% to 1.0% MAC (iii, iv) |
| Thickness—Outboard | 0.01% to 1.5% MAC (0.02% - 1%) (i) |
| Thickness—Inboard | 0.01% to 2.5% MAC (0.02% - 1%) (i) |
| Thickness—Airfoil Span | vii 0.01% to 5% MAC (0.02% - 1%) (i) |
| Camber—Midboard | a camber >0.005 & a camber <−0.005 and >−0.03 |
| | (a camber >0.01 & a camber <−0.01 and >−0.02) |
| | (S-Shaped) |
| Camber at Tip (side edge) | <0 (see outboard pitch) |
| Camber at 0.02 to 0.15 Chord | −0.01 to 0.01 (−0.005 to 0.005) |
| Pitch—Midboard | 0.4° to 3° |
| Air Angle of Attack—Outboard | −2° to 0° (−1º to 0°) [ii, median fluid angles of attack] |
| Pitch—Outboard | −1.5° to −0.1º (−1.0° to −0.2°) |
| Pitch—Midboard, Rotating Blade | a jet-forming at R < 0.8RMAX |
| Span A/R (Aspect Ratio) | 0.1 to 3 (0.2 to 2, 0.3 to 1) |
| Span at >95% max. Span | >0.5 |
| Span—Blade Blunt End | 5° to 60° (5° to 15°) |
| Objective—Tip (side edge) | ΔP_{L} on edge of 0%-12% avg. baseline wing loading |
| | (2%-10%, 3%-7%) |
| Objective—Outboard | (avg. ΔP_{L} of 0 to 0.4 kPa (0 to 0.25 kPa, 0. 0.05 kPa)) |
| Objective—Leading and Trailing | ΔP_{L} on edge of 0%-12% avg. baseline wing loading |
| Edge | (2%-10%, 3%-7%) |
| Objective—Algorithmic | vary surface to achieve avg. ΔP_{L} |
| Other Objective—Airfoil | no upwash, no backwash, ii, v |

i) comprising a sheet (adaptive) passively configured to decrease pitch in response to higher pressure differentials.
ii) outboard span is at least one tenth of baseboard semispan.
iii) with laterally-extending structural bulge.
iv) with longitudinally-extending payload bulge.
v) inboard span is at least four tenths of the baseboard semispan.
vi) feed air sequentially from the axis of rotation: a) pre-combustion air prior to the burner, b) bell containment air, c) jet-forming stream with 2°-20° inward vector, and d) a transitioning anulus vector for a smooth transition from the jet-forming stream blades at outer radius having vector parallel to oncoming air's angle.
vii) average pressure on the outboard pressure surface to a value less than 20% (<10%, <5%) of the average pressure on the midboard pressure surface.

By example, a sheet 6 that adaptively/passively reduces lift pressure in response to increased aircraft pitch is a 0.125 inch thick, 12 inch wide sheet of carbon fiber composite; the adaptive response could comprising curving of either the side edge 8 or trailing edge 9 upward due to the sheets flexibility or due to the elasticity couplings. Upward curvature of a span section at the trailing edge 9 is preferably configured to increase pitch stability by alleviating the wing's or platform's sudden change from positive to negative lift with slight changes in air's angle of attack. A structural vane 11 (see FIG. 12) preferably extends below a thin airfoil with spaces 18 to throttle higher pressure air through the vane 11.

The outboard span 1 embodiments of this invention are particularly useful for low A/R wings. Most preferred embodiments comprise side edge 8 chords greater than two thirds the length of the aircraft to which the wing is attached. An example of an application of an A/R less than 0.3 is a flattop aircraft 12 (see FIGS. 6 and 13) comprising relatively flat airfoil attached to the top of a fuselage 13 at a width of about twice the fuselage's width and length about equal to the fuselage's length. Solar cells 14 (see FIG. 5) could be placed on relatively flat airfoil's upper surface 15 and thin batteries could be placed on its lower surface. Preferable loadings of batteries is from 50% to 100% of the lift in the cruising configuration on a local area basis (i.e., on a force per area basis).

S-Shaped Camber—Preferably, the inboard span 16 comprises a camber >0.005, a camber <−0.005 and >−0.023, and an average thickness of 0.01% to 2.5 MAC (the low thickness allows for sections of thin sheets of fabric or plastic), and the inboard span 16 is preferably coupled with an outboard airfoil span 1 configured to reduce vortex magnitudes. These cambers describe an S-shaped camber (see FIG. 4), but without the obscurity that can be created by structural bulges that may be attached to the thin airfoil.

For a more-preferred airfoil span, the inboard (or midboard) span: a) comprises an average thickness of 0.01% to 1% MAC from 0 to 0.15 chord, b) is at least one third of a wingspan and is configured to cruise at a pitch between 0.4° and 3° (more preferably between 0.6° and 2°), c) is attached to a laterally-extending structural bulge 17 or a longitudinally extending payload bulge, and d) comprises a flat upper surface 19 from 0.02 chord to 0.15 chord.

More preferred is a midboard span designed to cruise with a flat upper 19 surface air angles of attack between −0.01° and 0.01° from 0.02 to 0.15 chord, with a lower surface of similar contour. This is consistent with a flat thin airfoil section having a camber between −0.01 and 0.01, more preferably between −0.005 and 0.005. More preferably, the upper and lower surfaces are at an acute dihedral angle. By example, the structural bulge may be located between 0.2 chord and 0.5 chord as a laterally extending spar. By example, a payload bulge 18 may be between 0.2 chord and 0.8 chord with a longitudinally-extending payload compartment.

The S-shaped camber has the advantage of providing increased stability (against vibrations/oscillations) for the mid-sections of towed platforms 20 connected to leading tiltwing via a joint (e.g., hinge joint 21) that allows transfers roll-stabilizing forces while enabling passive stability of the towed platform 20. FIG. 13 illustrates a flattop using a similar tiltwing 22 with leading and trailing propulsors 23 and elevons 24 to control the vector of the lead tiltwing 22.

Rotating Blades—An airfoil span comprising a midboard span and an outboard span is preferably the outer 20% to 40% of a rotating blade. The airfoil span is comprised of an outboard span, a midboard span, and a steady-state condition; the midboard span configured to generate pressure on a midboard pressure surface; the outboard span is comprised of a thickness ratio between 0.0001 and 0.05 and an outboard pressure surface; the steady state condition is configured to: a) reduce the average pressure on the outboard pressure surface to a value less than 20% (more preferably 2% to 10%) of the average [gauge] pressure on the midboard pressure surface. The pressure surface is the surface (e.g., lower surface of wing, pressure face of a fan) where pressure is increased as a result of aerodynamic forces; references to pressure are reference to gauge pressure. Typically, similar changes would occur to the absolute magnitude of negative gauge pressures on upper surfaces of wings and suction faces of fans and blades.

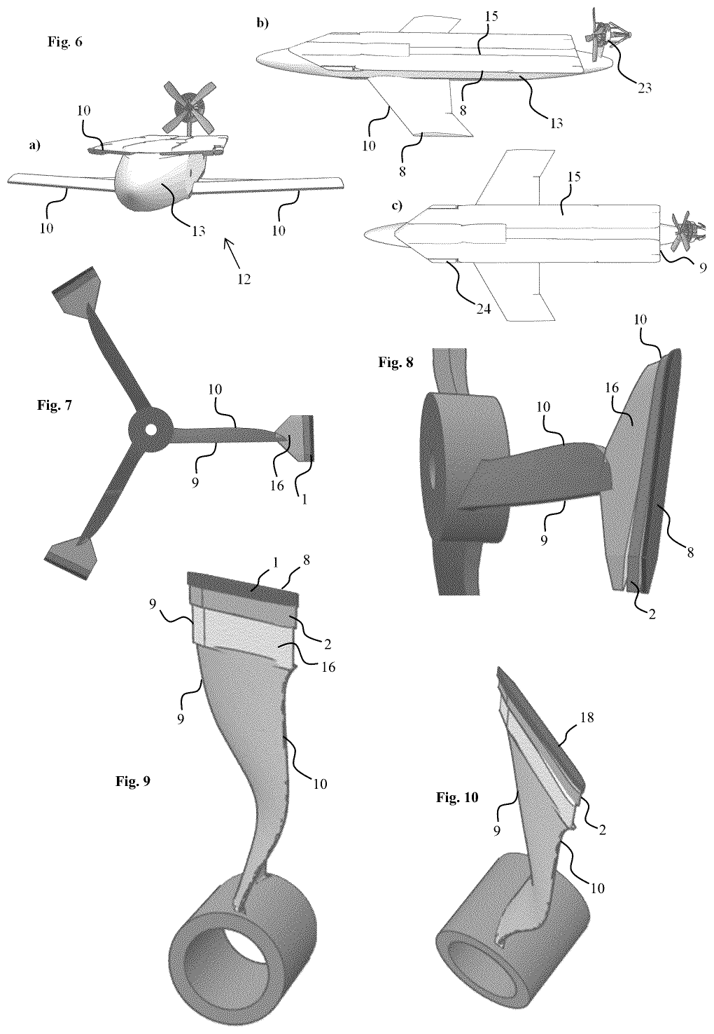

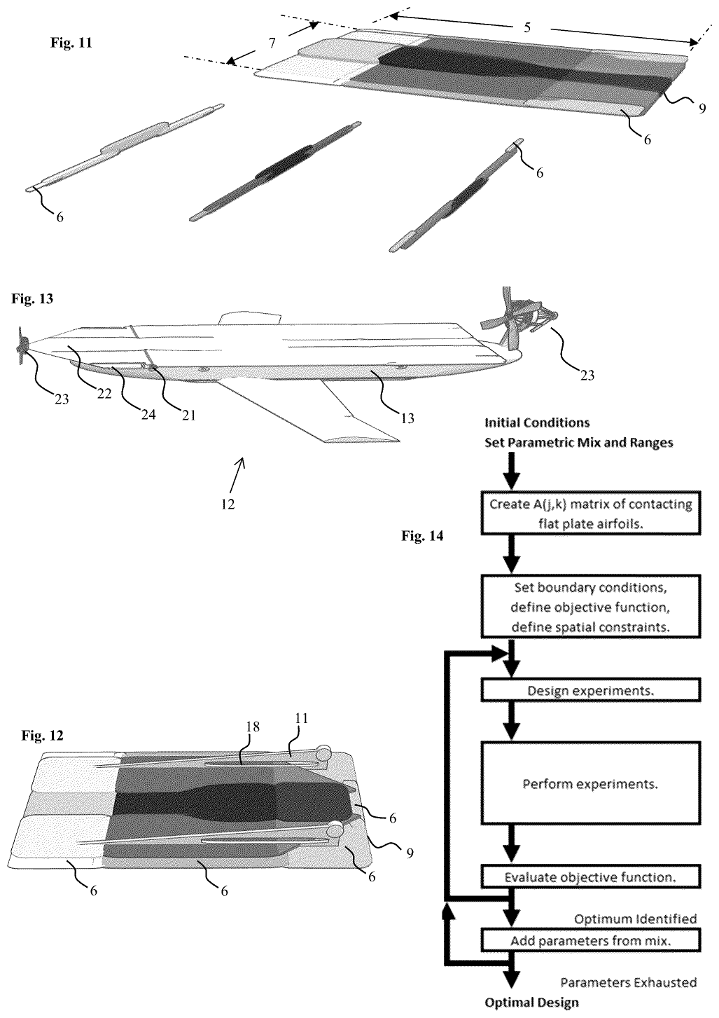

The preferred comprises an outboard span and a midboard span where the midboard span configured to generate pressure on a midboard pressure surface and the outboard span comprising an average thickness of 0.0001 and 0.05 MAC (see FIGS. 7-10). The blade's outboard span is configured to a) reduce pressure differences between suction and pressure surfaces to an avg. APL of 0 to 0.25 kPa (5 lb/ft2), b) reduce vortex magnitudes without backwash and c) operate at median fluid angles of attack between −2° and 0°.

For a more-preferred rotating blade: a) comprises a jet-forming wherein the jet-forming section is configured to accelerate air to form a jet of accelerated air inside 0.8 R, b) comprises a blunt end chord >5°, c) is coupled to at least one from group comprising a pre-combustion mixer, a burner, a compression means, an electric motor, and a connection to an expander, d) extends longitudinally from fore the pre-combustion zone to aft the burner, and e) is configured to feed air in the radial sequence: i) pre-combustion air prior to the burner, ii) bell containment air, iii) jet-forming stream with 2°-20° inward vector, and iv) a transitioning anulus vector for a smooth transition from the jet-forming stream blades at outer radius having vector parallel to oncoming air's angle.

A jet-forming embodiment may include baffle surfaces streamlined with preferred the jet flow patterns. The rotating blade may be: a) a fan blade that functions as a combustion bell containment; b) the rotating blade is part of a hybrid electric-fuel jet engine; c) the jet is powered by electricity from at least one from a list comprising a battery, a fuel cell, a solar cell, a diesel engine, and a turbine engine; c) the jet forming embodiment is comprised of multiple ductless rotating blade systems in sequence; and d) the airfoil superstructure comprises a structural vane along a constant-radius path. The pressures on the pressure face of jet-forming spans of a rotating blade are preferably at least ten times (“>10×”) the average pressure of outboard spans of the rotating blade (more preferably >20×). Multiple axially-spaced blade devices may be used to create the jet discharge. The diesel engine is preferably comprised of steel sleeves in a carbon fiber composite case configured for air cooling with surrounding air at temperatures less than 270 K and operable with low-pour-point fuel; an ultra-light highly-efficient diesel engine.

More on Relaxing Surfaces—The embodiments of this invention are described in terms of a cruising configuration, and the wing embodiments are most preferably at L/D>57:1; this translates to a surface (i.e., surface integral of pressure) that is effectively at 0.2<θ°<1.0 (air angles of attack). This translates to a number of approaches on design, including: a) the pressure-generating benefit of lower surfaces >1.0° should be coupled to harvesting and relaxing surfaces <0.50 that recover the lift pressure at high L/D, b) at outboard (i.e., relaxing) surfaces where the average air angle of attack is <0° the pitch angle should become increasingly negative; b) toward the side-edge, θ°<−2.0 are acceptable since these generate induced thrust and the limiting criteria on the change in pitch is so as not to induce turbulence due to the sudden changes, c) the outboard spans of this invention are defined exclusive of winglets but include elevons as steady-state cruising positions, and in general, the outboard span may be adjustable through known active methods (e.g., like elevons) or passive methods (e.g., thin sheets that bend more in response to increasing lift pressures at the side edge) to better function at non-cruising conditions, and d) the relaxing surfaces (i.e., surfaces at θ°<−2.0) preferably have increasing spans toward the aft (see FIG. 12). Elevon-type configurations with a near constant torque loading (e.g. a spring loading) and may include both spring and servo actuation.

Pressures Near Edges—A typical contemporary jet has a wing load around 740 kg/m² (150 lb/ft²). General aviation aircraft wing loadings are lower, typically near 25 lb/ft². The more-preferred wing loads of the embodiments of this invention are 3 lb/ft²-50 lb/ft² (most preferably 7-30 lb/ft²); this complements use of solar power and is preferably with use of single membrane/sheet flat spans (not accounting of solar panels on upper on top of the membrane) where both upper and lower surfaces provide lift.

Due to the wide range of wing loadings, a relative specification of targeted side-edge lift pressure (ΔP_{L}) is preferred. Side edge ΔP_{L} are preferably 0% to 12% the average wing loading, more preferably 2% to 10%, and most preferably 3% to 7%.

Variable Speed Blade Operation—For a fixed outboard section of a rotating blade, the air angles of attack of the relaxing section may vary with speed of rotation. Method known in the science for changing the pitch of a blade may be used to change the pitch of all or part of the blade. Also, adaptive sheets may be used on the outboard span, similar to afore-mentioned wing embodiments. The equivalent of elevon edges may be used. The semispan (as used in describing wings) of rotating blade embodiments, the semispan is the outer 20% to 40% of the blade radius. Lower radii spans are, preferably, of contemporary designs. Higher pitches, relative to contemporary designs, at radii less than about 0.7 R will create jet flows. Similar to axially-spaced rotor sections of a turbojet, the blade embodiments of instant invention may be used in multiple rotor sections that are axially spaced with decreasing maximum radii toward the aft.

Configured Reduce Tip Vortex Magnitude—Instant invention has applications in dozens of devices, and each of those devices may have preferred specifications dependent on the application. Hence, details of the preferred configurations are determined by an optimization algorithm (see FIG. 14). The algorithm includes the analysis of prototypes; those prototypes may be digital (simulation) or physical. The algorithm provides a single optimum design specification based on the specification of the design degrees of freedom.

The invention is both the algorithm and airfoil devices as solutions by the algorithm. The solutions a limited by the design parameters, limits, and ultimate specification which are the same as afore-described embodiments of this invention. More specifically, the solutions are for aircraft at L/D>27, more preferably L/D>40, and most preferably >57; these solutions are indirectly specified by the predominance of surfaces having pitch angles between 1e5m and 1.5° (more preferably between −1.0° and 1.0°) and by initial conditions close to the true optimum in objective functions weighted heavily on LID; those initial conditions are of a design that is a practical realization of the flat plate airfoil that uses outboard sections of low thickness and negative air angles of attack.

FIG. 14 is the optimization algorithm. Table 2 completes this algorithm with further specification of ranges, conditions, function, and constraints. The A(j,k) matrix of the airfoil is a rectangular space of divided rows (extending the span) and columns (extending the length) defining j×k airfoil elements; the airfoil elements sections in the same row have the same chord and the airfoil sections in a column have the same span. The number of rows and columns may be increased in the course of the algorithm. The parameter mix are specifications of the airfoil elements, how the airfoil elements connect, variations at the matric edges, and additions to the airfoil.

TABLE 2
Specifications that supplement the optimization algorithm.

| | |
|---|---|
| Algorithm Freedom | Further Specification of Algorithm Freedom |
| Initial Conditions | The initial layout of the matrix with a default of flat and the option of using a |
| | previously optimized solution having similar Spatial Constraints and Initial |
| | Conditions. |
| Spatial Constraints | Total length, total width, total weight, symmetry center longitudinal-vertical |
| & Boundary | plane for aircraft with smooth connectivity of laterally-extending edges that |
| Conditions | contact in matrix, a specified differential pressure at an edge. |
| Parameter Mix | a) camber, b) thickness (including 0 for edges), c) continuity/smoothness of |
| | edge transitions, d) location and size of laterally-extending structural bulge |
| | including smoothing of transition, e) location and size of payload bulge |
| | including smoothing of transition, f) sweep angle of front edge, g) vertical |
| | vanes including side edge vanes, h) splitting of airfoil sections to allow for |
| | greater complexity in curvature/cambers, i) addition of control surfaces, j) type |
| | and placement of propulsor, k) laterally-extending axes of pivot, 1) specification |
| | of lateral connectivity at a specified fraction of chord (e.g., horizontal lateral |
| | connectivity of thickness center points at 0.5 chord), m) overlap of airfoil |
| | elements. |
| Parameter Ranges | As specified in previous embodiments and paragraphs. |
| NOTE: | The matrix is defined as common spans and chord lengths that separate the flat |
| | plate airfoil sections. Variations in the ″common spans″ can be in the |
| | parameter mix; alternatively, an increase in ″j″ and ″k″ (i.e., splitting of airfoil |
| | sections) will provide this design degree of freedom. |
| Objective Function | Is a calculated value that may be one performance characteristic such a L/D, or |
| | it may be a weighted combination of characteristics. The evaluating of the |
| | objective function may take additional calculations such as the surface integral |
| | of pressure over the entire device. |
| Design of | The topic of ″designed experiments″ provides a variety of way to maximize |
| Experiments | information from the fewest experiments with varying parameters. |

The solution process identified in the algorithm starts with a base case solution and incrementally adds complexity. The algorithm is reasonably solvable by the control of the number of parameters being evaluated in designed experiments in any iteration. By example, the first (i.e., base case calculation) pass of the algorithm would include a matrix of j=3 rows and k=5 columns of airfoil elements where the pitches, widths, and lengths are varied within the spatial constraints.

Subsequent to the baseline optimization, the “Add parameters from the mix” routine adds additional parameters to be optimized. The selection of parameters to add may be random in selection but with reasonable limits in the number of new parameters (e.g., 3 new parameters each iteration). The unique optimum solution is independent of the manner in which parameters are added; however, the experiment time for total solution is dependent upon the selection. The experiments may be computational or actual field tests of prototypes; computational experiments with periodic building and testing of prototypes is preferred.

Preferred Hybrid Engine—Published PCT application WO 2022/169828 A1 is incorporated herein by reference.

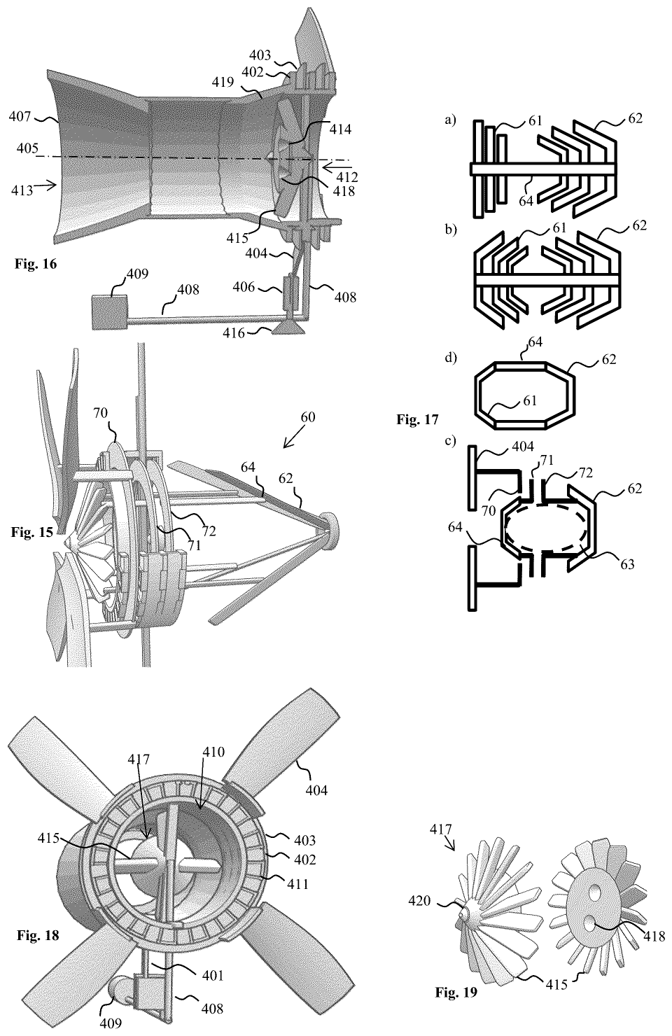

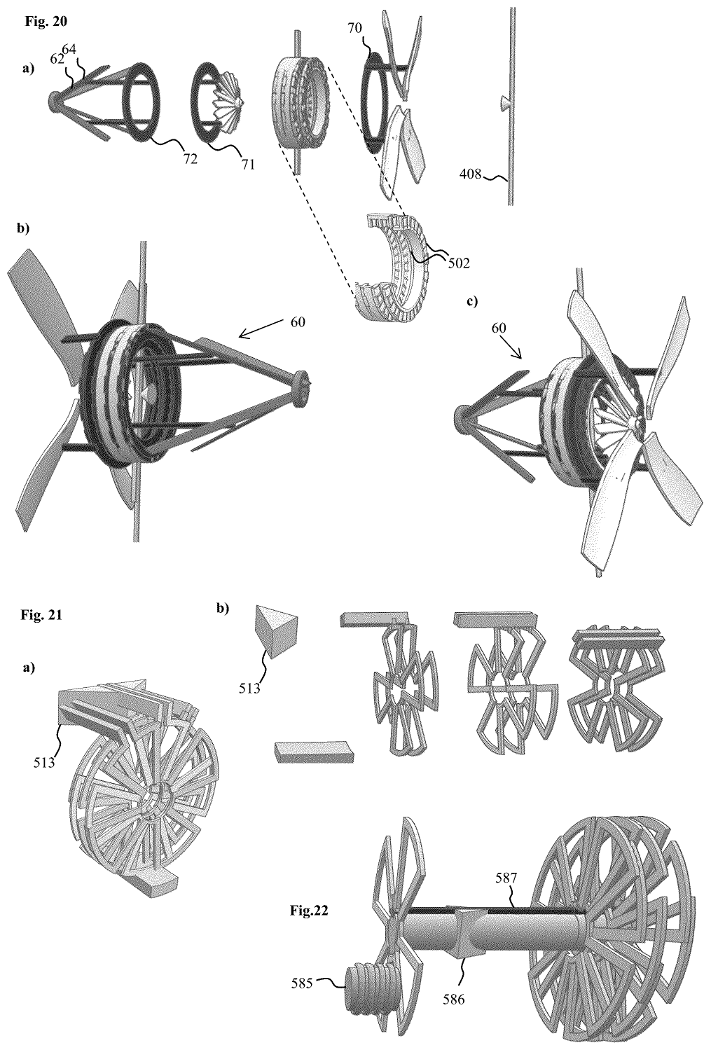

For higher-speeds (e.g. >300 mph) the preferred aerial vehicle propulsor is a hybrid engine in which the same fuel (e.g. hydrogen, ammonia) is used to provide power to fuel cells and a combustor such as illustrated by FIGS. 16 and 18. A preferred hybrid electric-fuel engine comprises an electric motor, a motor circuit 401, an axial-flux stator 402, a rotor 403, a propeller 404, a longitudinal axis 405 of rotation, a fuel cell 406, a combustor, a combustor discharge nozzle 407, a fuel line 408, a first thrust mode, a second thrust mode, and a fuel tank 409. The said axial-flux stator 402 comprises an open core 410, a connection to an aircraft, electromagnetics angularly spaced around the core, and an axial air flow through the core and along the longitudinal axis 405 of rotation, wherein the axial-flux stator 402 is configured to rotate the rotor 403 and propeller 404 to provide propeller 404 thrust. The motor circuit 401, fuel cell 406, fuel line 408, and fuel tank 409 are configured to power the axial-stacked stator 402. The combustor comprises an air entrance 412, an air exit 413, and a fuel nozzle 414, said combustor is configured with the fuel line 408 and fuel tank 409 to provide jet thrust. The first thrust mode comprises only propeller 404 thrust, and the said second thrust mode comprises both propeller 404 thrust and jet thrust.

More preferably, the open core 410 is configured to direct air into the air entrance 412; where the directed air may be from 5% to 100% of the air flowing through the core. A propeller 404 thrust efficiency is defined as thrust energy divided by the energy of the fuel used to generate that thrust. A jet thrust efficiency defined as thrust energy divided by the energy of the fuel used to generate the jet thrust. Preferred operations comprise a control system 416 and a transition velocity for transitioning from the first thrust mode to the second thrust mode where the transition velocity is where the propeller 404 thrust efficiency has decreased with increasing velocity until it is equal to the jet thrust efficiency. Propeller 404 blades may extend radially into the open core 410, radially outward, or both radially inward and outward; and the propeller 404 blades may fold back at higher velocity to enable a thrust mode without propeller 404 operation such as a ram jet mode of operation.

More preferably, a freely rotating combustor 417 with blades 415 rotates about the longitudinal axis 405 of rotation near the air entrance 412 and within the open core 410 and comprising a fuel inlet, a fuel nozzle 414, a combustion bell 418, a forward blade surface, and trailing blade surface said combustion bell 418 located on the trailing side of the rotating combustor 417 between the forward and trailing blade surfaces. The nozzle discharges fuel in the combustion bell 418 and the fuel burns to form a thrust wherein the rotating combustor 417 is configured to vector thrust in both angular and forward directions. Preferably, the angular rotation directs air into the combustor to feed the combustion bell 418 with air.

Combustion generates a burner thrust on the rotating combustor 417, and the burner thrust is transferred to an aircraft to sustain or achieve higher-velocity flight. Velocities may exceed mach 1. More-preferred rotating combustor's blades 415 are high-pitch blades 415 with preferred pitch angles between 50 and 85 degrees. This translates to subsonic blade velocities even when velocities are supersonic. Preferably, multiple blades are spaced angularly and longitudinally on the rotating combustor to allow thrust transfer along the entire vertical-lateral plane extending around the rotating combustor to duct walls 419 containing the combustion. Duct walls 419 may be the same as core walls, or they may be separate when a propeller 494 (i.e. fan) rotates inside the core.

The rotating combustor is configured to rotate with minimal resistance to air flow while providing a surface for burner thrust to be directed to the aircraft to which the hybrid electric-fuel engine is connected. FIG. 20 shows a bearing sleeve 420 on which a bearing is mounted to enable rotation and thrust force transfer. The preferred rotating combustor comprises centrifugal air flow vanes on the front surface nose, multiple high pitch blades, back-side combustion bells, and backside surfaces configured to collect thrust force in a mostly forward vector but with complement to rotation to optimize performance.

The embodiments of this invention have common applications in solar planes and transformer drones. This invention includes use of the embodiments in combinations and applications beyond specific illustrations of this document.

The FIG. 21 exploded view of an induction device illustrates a three-phase configuration with each phase comprising two discs connected in a parallel circuit. The FIG. 21 induction device has outer perimeter electrical connectivity and is preferably paired with an induction device having electrical connectivity along an inner perimeter, wherein there is a rotation one of the coupled devices relative to the other coupled device. More specifically, either of the coupled devices may be the rotor with the other being the stator.

By example, the FIG. 21a induction device may be the rotor, wherein the reaction the reaction element is a rotor comprising a rotor induction circuit on a rotor board, said rotor board configured with cores of similar size and geometry as stator board induction circuits. Also, said rotor board may be one of a plurality of rotor boards, said plurality of rotor boards of a configuration selected from the group comprising: parallel closed-circuit rotor induction circuits, parallel rotor induction circuits configured at phase angles equal to stator board phase angles, parallel rotor induction circuits configured to interact with a stationary excitation magnetic field system in an induction generator (said induction generator configured to convert rotational energy to electrical current), and parallel rotor induction circuits configured to interact at least one core of one of the stator boards in an induction generator (said induction generator configured to convert rotational energy to electrical current). FIG. 22 illustrates a stationary solenoid 585 as the source of the stationary excitation magnetic field. The control unit 586 preferably control a plurality of circuit connectivity options 587 made possible by the busbar connection circuits. The control unit optionally is in communication with the stationary solenoid to enable the FIG. 22 device to switch from induction motor operation to induction generator operation.

Preferably, the solenoid 585 is configured for high reluctance provided by a larger relative magnetic core mass with a coils of multiple turns and lower DC current. Operational configurations include a configuration where the solenoid's magnetic field induces a current in a rotating rotor board, and wherein, the induced current is transferred to a stacked rotor coupled with a stator of matching phase and core configuration. The configuration approaches generation of pure DC current in the stator system available for used by external circuits.

The FIGS. 9 and 10 blades may be designed to progress in the aft direction as the radius increases. That aft direction progression is illustrated by FIGS. 15, 17, and 20 where the relaxing section is not explicit. The connection to expanding blades may be at the axis of rotation or a radial position as illustrated by FIG. 17.

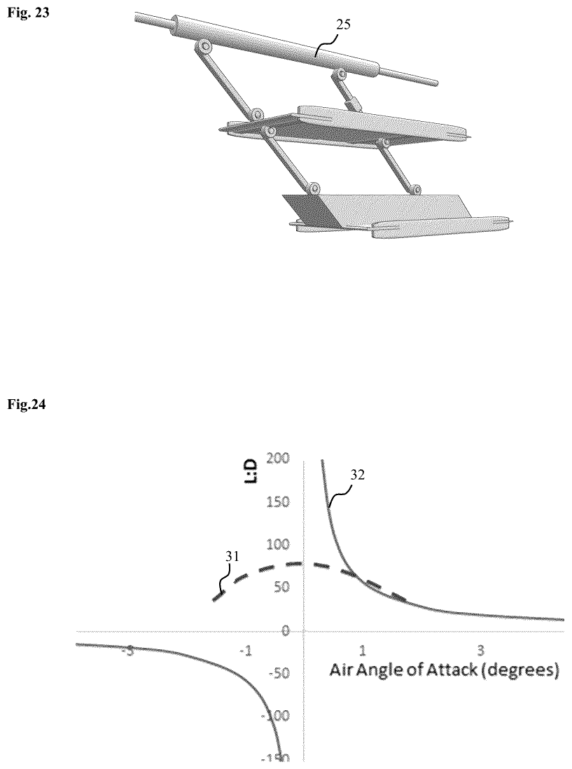

Towed Aerial Vehicle—The embodiments of this invention include aircraft towed along guideways. FIG. 23 illustrates an aerial towed vehicle pulled along a zipline-type guideway by a linear motor 25.

Illustrative Example 1—FIG. 24 provides estimates of the performance of a contemporary airfoil 31 having a maximum thickness of about 6% MAC and a thinner ideal flat plate airfoil 32. Most notable in the difference of performances is that that the flat plate airfoil has rapid changes in L/D at −2°<θ<2°; this rapid change in L/D, including sudden change from positive to negative values, is an important enabling feature of the embodiments of this invention and separates this invention from prior art. Airfoils with low thicknesses and low cambers approach the performance of the flat plate airfoil.

Shear drag and leading edge thickness detract from the ideal air foil performance. Shear drag correction is less than 5% for air angle of attacks greater than about 0.4° and thickness >0.005 MAC. Leading edge thickness detracts from performance; the remedies include using a flat thin leading edge (e.g., FIG. 4c) and a low aspect ratio; the correction is about 10% for substantially rectangular airfoils (e.g., FIG. 5) having aspect ratios less than 0.5. A towed platform embodiment provides the needed pitch stability.

The remaining, significant, detraction from performance are side-edge vortex losses over the large chord length with constant span. The embodiments of this invention mitigate the vortex losses to about a 20% reduction in L/D from the ideal case.

Accordingly, an airfoil superstructure having an aspect ratio of 0.4, an average air angle of attack of 1° on generating spans over 80% of the semispans, and an average air angle of attack of −0.4° on outboard spans over 10% of the semispans has an overall L/D of greater than 38:1 at scales near 1000 lb. Part of the pressure generated on the lower surfaces of the generating spans spreads over the outboard spans where aerodynamic forces reduce the magnitude of the pressure to values near 1 lb/ft² (gauge pressure) at the side edge. When operating at atmospheric pressure and 100 mph, the average airfoil load is about 10 lb/ft².

1. An airfoil span comprising an outboard span adjacent to a midboard span,
the midboard span configured to generate pressure on a midboard lower surface, and
the outboard span comprising an average thickness between 0.0001 and 0.015 MAC and configured to: a) reduce pressure differences between upper and lower surfaces, b) reduce vortex magnitudes without upwash and c) operate at median fluid angles of attack between −2° and 0°.

2. The airfoil span of claim 1, the outboard span comprising an average thickness less than 0.01 MAC and a median pitch between −1.5° and −0.1°.

3. The airfoil span of claim 1, the outboard span further comprising a sheet configured to passively decrease pitch in response to higher lift pressures.

4. The airfoil span of claim 1 wherein the outboard span is part of a baseboard wing, the baseboard wing comprising an aspect ratio between 0.1 and 3 and wherein >95% of the baseboard extends laterally at least 95% of the baseboard's wingspan.

5. The airfoil span of claim 1, the outboard span further comprising a negative camber; and wherein the airfoil span is part of a wing comprising edges wherein the wing is configured to operate at cumulative lift pressures between 0 and 0.25 kPa at the edges.

6. The airfoil span of claim 1 wherein the outboard span is connected to a structural vane wherein the vane is configured to increase the longitudinal rigidity of the outboard span.

7. The airfoil span of claim 1 wherein the outboard span is part of at least one from the group wing, fan, turbine, blade, propeller, flattop aircraft, and towed platform.

8. The airfoil span of claim 4, wherein the outboard span is the outer one tenth of the baseboard wing's semispan.

9. An inboard span comprising a camber >0.005, a camber <−0.005 and >−0.023, and an average thickness ratio between 0.0001 and 0.025; wherein the inboard span is coupled with an outboard airfoil span configured to reduce vortex magnitudes.

10. The inboard span of claim 9 further comprising an average thickness of 0.01% to 1% MAC from 0 to 0.15 chord, and wherein the inboard span is configured as an S-shaped camber.

11. The inboard span of claim 9 wherein the inboard span is at least one third of a wingspan and is configured to cruise at a pitch between 0.4° and 3°.

12. The inboard span of claim 9 wherein the inboard span is attached to at least one from the group comprising a laterally-extending structural bulge and a longitudinally extending payload bulge.

13. The inboard span of claim 9 comprising a flat upper surface from 0.02 chord to 0.15 chord.

14. The inboard span of claim 9, wherein the outboard airfoil span is the outer one tenth of the baseboard wing's semispan wherein the inboard span is at least four tenths of the baseboard wing's semispan.

15. An airfoil span comprising an outboard span, a midboard span, and a steady-state condition;
the midboard span configured to generate pressure on a midboard pressure surface; the outboard span comprising a thickness ratio between 0.0001 and 0.05 and an outboard pressure surface;
the steady state condition configured to: a) reduce the average pressure on the outboard pressure surface to a value less than 20% of the average pressure on the midboard pressure surface, b) reduce vortex magnitudes without backwash and c) operate at median fluid angles of attack between −2° and 0°.

16. The airfoil span of claim 15 further comprising a jet-forming wherein the jet-forming section is configured to accelerate air to form a jet of accelerated air inside 0.8 R and wherein the airfoil span the outer 20% to 40% of a rotating blade.

17. The airfoil span of claim 15 further comprising a blunt end chord >5°.

18. The airfoil span of claim 15 wherein the airfoil span is coupled to at least one from group comprising a pre-combustion mixer, a burner, a compression means, an electric motor, and a connection to an expander.

19. The airfoil span of claim 15 wherein the rotary airfoil extends longitudinally from fore the pre-combustion zone to aft the burner.

20. The airfoil span of claim 15 wherein the compression means is configured to feed air sequentially from the axis of rotation: a) pre-combustion air prior to the burner, b) bell containment air, c) jet-forming stream with 2°-20° inward vector, and d) a transitioning anulus vector for a smooth transition from the jet-forming stream blades at outer radius having vector parallel to oncoming air's angle.
